(19) United States
(12) Patent Application Publication
(10) Pub. No.: US 2011/0032266 A1
(43) Pub. Date: Feb. 10, 2011

(54) GLARE DETECTION AND MITIGATION METHOD FOR A PHOTO-SENSITIVE DISPLAY DEVICE

(75) Inventors: ANDREW P. HARBACH, KOKOMO, IN (US); RIAD I. HAMMOUD, PITTSBURGH, PA (US)

Correspondence Address: Delphi Technologies, Inc., M/C 480-410-202, P.O. Box 5052, Troy, MI, 48007, US

(73) Assignee: DELPHI TECHNOLOGIES, INC., TROY, MI (US)

(21) Appl. No.: 12/537,594

(22) Filed: Aug. 7, 2009

(51) Int. Cl. G09G 5/02

(52) U.S. Cl. 345/589

(57) ABSTRACT

A display device having integral photo-sensors for touch sensing is used to detect and mitigate the effects of veiling glare that obscures information being conveyed by the display device. The photo-sensors are periodically sampled to identify optically saturated regions of the display device. If the saturated regions of the display device are being used to convey relevant information, one or more counter-measures are initiated to mitigate the effects of the glare. The counter-measures may include: increasing the display brightness at least in the identified glare region, tilting the display or its cover lens away from estimated direction of the glare source, re-sizing or re-formatting the displayed information, using an alternate display device to convey the information, and presenting the information with a different layer of a multi-layer display.

### TECHNICAL FIELD

The present invention relates to display devices including integral photo-sensors for touch sensing and/or imaging, and more particularly to a method of operation for detecting glare and mitigating its effects.

### BACKGROUND OF THE INVENTION

Various manufacturers have introduced active-matrix thin-film transistor electro-chromic (LCD or OLED, e.g.) multi-touch screen displays, where photo-sensor elements integrated into the pixel matrix are used to optically detect user touch points. See, for example, the U.S. Pat. No. 5,172,104 issued to U.S. Philips Corporation on Dec. 15, 1992. The photo-sensor elements have also been used for imaging purposes, such as for scanning an object placed on the screen of the display device, or even imaging a user of the display device. In spite of the advantages such display devices offer, they still suffer from image wash-out due to veiling glare when used in a high ambient lighting environment such as in the console or instrument cluster of a motor vehicle.

### SUMMARY OF THE INVENTION

The present invention is directed to a novel method of operation for a display device with integral photo-sensors that detects veiling glare and mitigates the effects of the detected glare. The photo-sensors are periodically sampled to identify optically saturated regions of the display. If the saturated regions of the display are being used to convey relevant information, one or more counter-measures are initiated to mitigate the effects of the glare. The counter-measures may include: increasing the display brightness at least in the identified glare region, tilting the display or its cover lens away from an estimated direction of the glare source, re-sizing or re-formatting the displayed information, using an alternate display device or communication medium to convey the information, and presenting the information with a different layer of a multi-layer display.

### BRIEF DESCRIPTION OF THE DRAWINGS

FIG. 1 is an illustration of a reconfigurable display for a motor vehicle, including an instrument cluster display device, a touch-screen display device installed in the center console of the vehicle, and a microprocessor-based display controller for operating the display devices and carrying out the method of this invention.

FIG. 2 is a diagram of a color LCD display with an integrated photo-sensor array.

FIG. 3 is a flow diagram representing a software routine executed by the display controller of FIG. 1 for carrying out the method of this invention in respect to the center console display device.

FIGS. 4A and 4B diagrammatically illustrate glare mitigation by controlled tilting of the display device or cover lens. FIG. 4A depicts a veiling glare due to directly incident sunlight, and FIG. 4B depicts a tilt adjustment of the cover lens that mitigates the veiling glare.

### DESCRIPTION OF THE PREFERRED EMBODIMENT

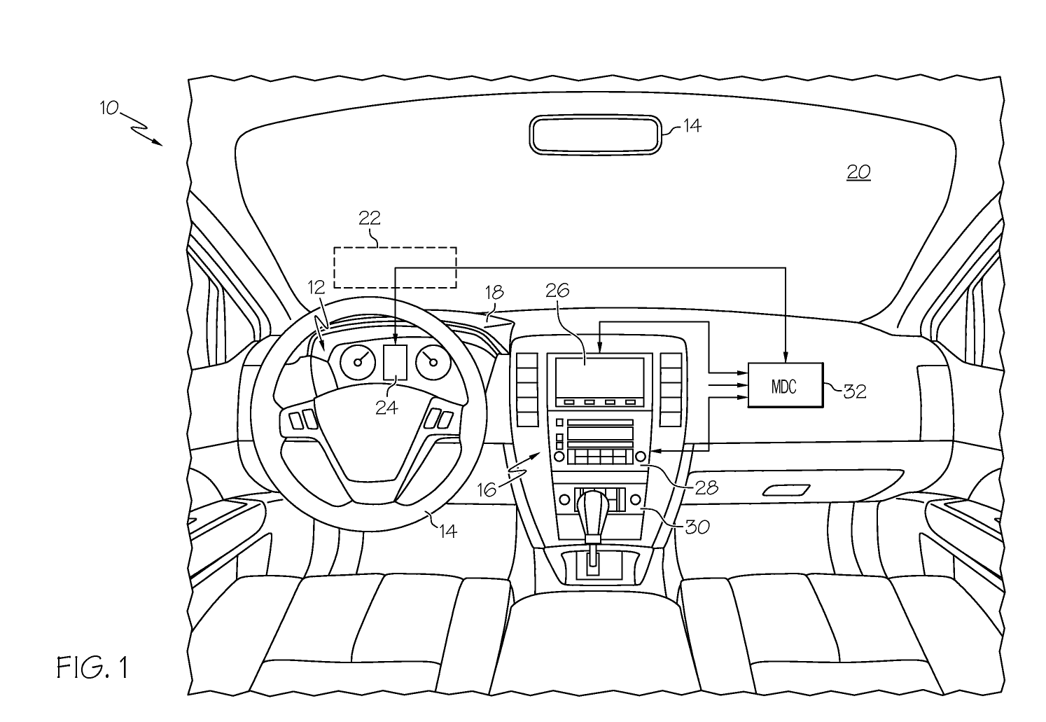

Referring to the drawings, and particularly to FIG. 1, the reference numeral 10 generally designates the front portion of a vehicle passenger compartment. Display devices are ordinarily installed in an instrument cluster 12 forward of the steering wheel 14, or in a center console 16, although a head-up display unit (not shown) mounted on the instrument panel 18 under the windshield 20 can also be used to project information from a display device onto a lower region 22 of windshield 20. In the illustrated embodiment, a relatively small reconfigurable LCD display device 24 is mounted in the instrument cluster 12 for displaying vehicle status or system information, and a relatively large reconfigurable LCD display device 26 is mounted in the upper portion of center console 16 for displaying navigation maps and information. As is customary, an audio control panel 28 and an HVAC control panel 30 are mounted in the center console 16 below the display device 26.

The information presented on the display devices 24, 26 is controlled and coordinated by a microprocessor-based display controller (MDC) 32, which preferably also interfaces with the audio control panel 28 in order to present critical information by voice using the vehicle audio system when necessary. Inputs to the MDC 32 include, for example, user switch state or touch screen data, and vehicle system data. Of particular relevance to the present invention, MDC 32 also samples photo-sensor information provided by one or more of the display devices 24, 26 to detect image wash-out due to veiling glare from sunlight or another light source, and to mitigate the effects of the glare.

Reconfigurable LCD display devices such as the instrument cluster display 24 and the console display 26, as well as other back-lit electro-chromic or pixilated-emissive displays (OLED displays, for example), are particularly susceptible to wash-out due to veiling glare from strong light sources, particularly sunlight. When sunlight direct impinges on a portion of the display area, it washes-out that portion of the display, obscuring information that would otherwise be viewable by the occupants. This can be prevented to some degree by providing hood or brow features on the console 16 and instrument panel 18 to shade the display devices 26 and 24 from ambient light, but such features can be undesirable from a design standpoint, and can also prevent a tall occupant from easily viewing upper portions of the displays.

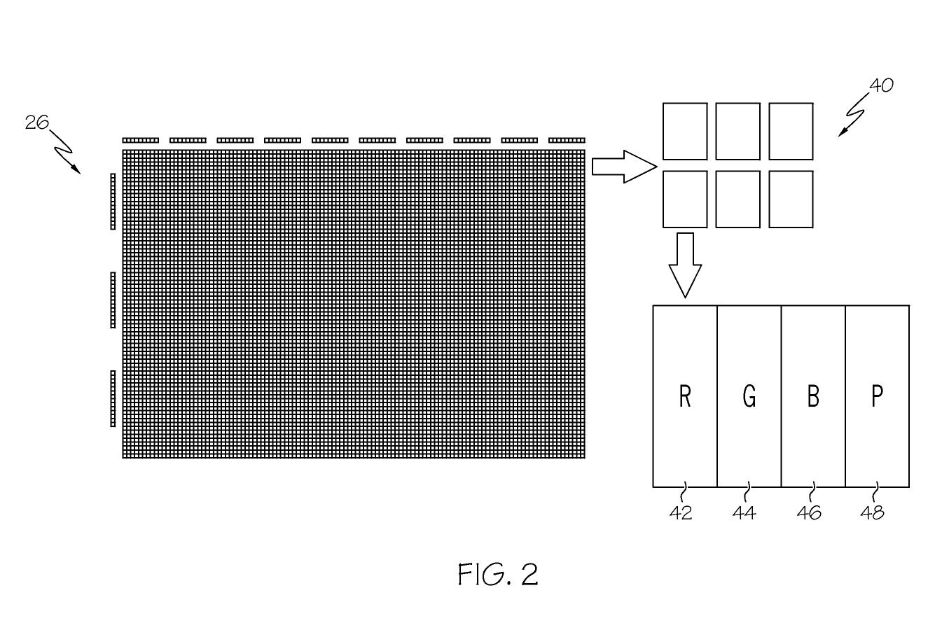

The present invention addresses the veiling glare issue by utilizing touch-screen display devices with integral photo-sensor arrays, and providing the photo-sensor data to MDC 32 for the purpose of detecting the presence of veiling glare and mitigating its effects by adjusting the display device(s) or the way in which the information affected by the glare is displayed. FIG. 2 illustrates a known way in which a photo-sensor array is integrated into a color LCD display such as the console mounted display device 26. Referring to FIG. 2, the display device 26 contains a rectangular matrix of color pixels, a subset of which are designated by the reference numeral 40, and each color pixel is defined by a red (R) sub-pixel 42, a green (G) sub-pixel 44, a blue (B) sub-pixel 46, and a photo-sensor (P) sub-pixel 48. While the display manufacturers have provided the distributed array of photo-sensor sub-pixels 48 for the purpose of detecting user touch points on the screen or cover lens of the display device 26, the present invention utilizes the photo-sensor data in a new and surprising way to detect and localize veiling glare due to strong light impinging on the display device 26.

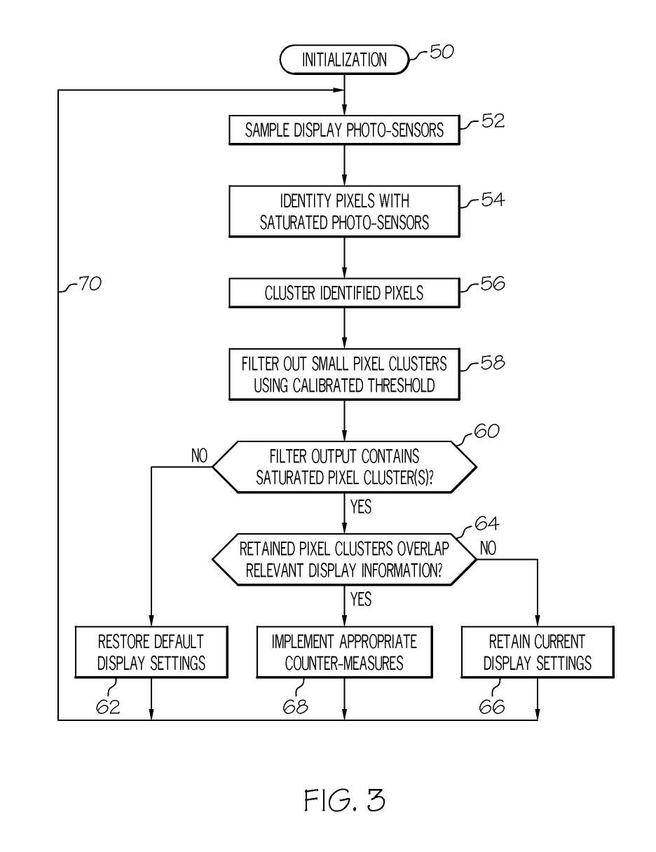

The flow diagram of FIG. 3 represents a software routine executed by MDC 32 according to this invention during the operation of the center console LCD display device 26. Of course, a corresponding routine may also be executed for the instrument cluster LCD display device 24, if desired. Referring to FIG. 3, the block 50 is first executed to initialize various parameters, thresholds and display settings prior to repeated periodic execution of a routine defined by the blocks 52-68. Block 52 samples light intensity data produced by the various photo-sensors of the display device 26, and block 54 compares the sampled data to a calibrated saturation threshold to identify the display pixels for which the respective photo-sensors, if any, are saturated due to strong directly impinging ambient light. This effectively creates a saturation map of the display device 26, and the block 56 is then executed to group the saturated pixels into clusters by bounding display regions consisting only (or primarily) of contiguous saturated pixels. The block 58 then size-filters the pixel clusters formed by block 56 to ignore clusters smaller in area than a calibrated threshold to rule out mitigative action due to minor glare from transitory point sources of light. Block 60 determines if the output of the size-filter includes one or more saturated pixel clusters. If not, block 62 is executed to restore the default settings of the display device 26; if so, block 64 is executed to determine if the pixel cluster(s) overlaps relevant display information. If block 64 is answered in the negative, block 66 is executed to retain the current display settings; if block 64 is answered in the affirmative, block 68 is executed to implement one or more counter-measures for mitigating the effects of the glare. In any event, the routine is then re-executed, as indicated by the flow diagram line 70.

The counter-measures for mitigating the effects of detected veiling glare will depend to some extent on user preference and on the importance of the information being obscured by the veiling glare. But in general, the counter-measures fall into one or more of the following categories: locally or globally increasing display brightness to compensate for the glare, changing the format of the displayed information, changing a display or lens characteristic that minimizes or eliminates the glare, and conveying the glare-obscured information visually using a different display device (for example, instrument cluster or head-up displays) or audibly using the vehicle audio system, for example.

The format of the displayed information can be changed, for example, by increasing the font size of the displayed text or symbols, or by re-sizing or re-arranging the displayed information so that the overlap with the regions of veiling glare is minimized or eliminated.

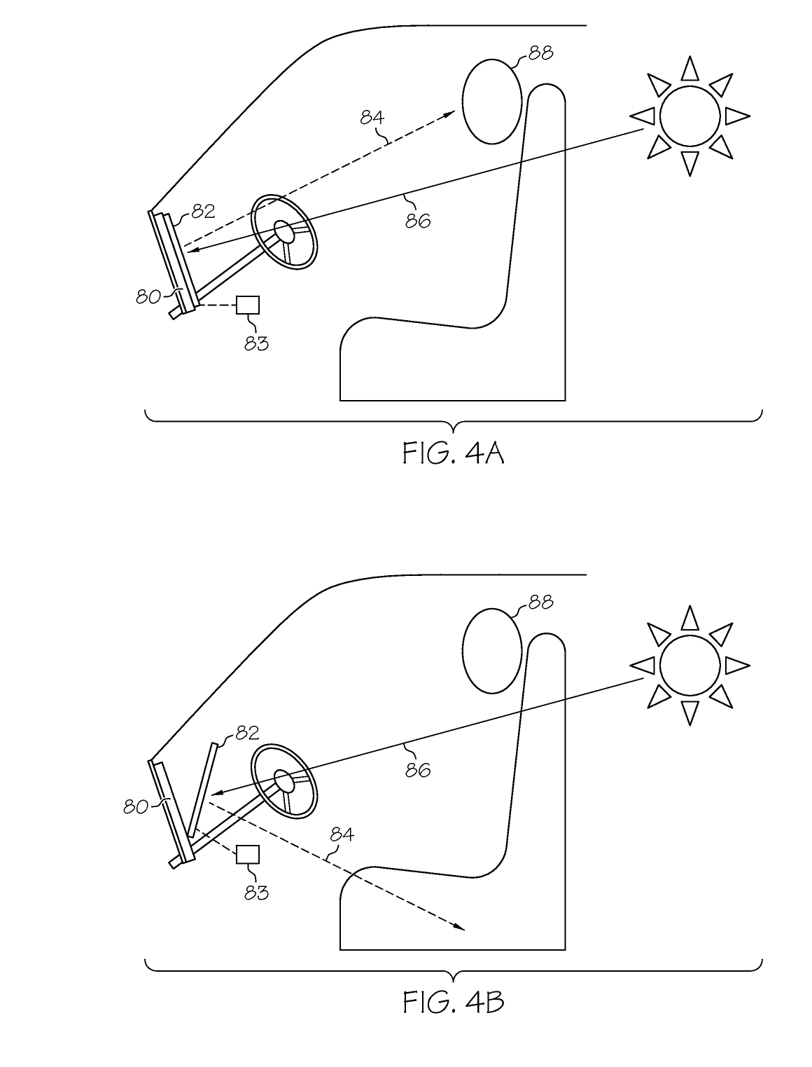

While changing the format of the displayed information to mitigate the effects of glare is advantageous because it effectively addresses the glare problem without impacting system cost, the display may be equipped with one or more mechanisms for mitigating the glare without changing the format of the displayed information. For example, the display device may be mounted in a fixture that permits controlled tilting of the display device or a cover lens mounted on the driver-side of the display device. This approach is illustrated in FIGS. 4A-4B in respect to an instrument cluster display device 80 having a controlled tilt cover lens 82 and actuator 83, and shows that the glare 84 due to directly impinging sunlight 86 can be shifted away from the driver's face 88 by activating the actuator 83 to suitably tilt the cover lens 82. The required tilt adjustment can be determined by estimating the sunlight angle of incidence based on the size, current location, shape and location history of the saturated pixel cluster(s), and then tilting the cover lens 82 away from the estimated angle of incidence. Alternately, a polarization characteristic of the display or cover lens can be mechanically or electronically adjusted to mitigate the glare. A further alternative involves configuring the display device 26 as a multi-layer display, and presenting the glare-obscured information on a different display layer that is shielded from the incident sunlight.

In summary, the method of the present invention provides a novel and cost-effective way of detecting the presence of veiling glare on a display device in a high ambient lighting environment, along with counter-measures for mitigating the information-obscuring effects of the veiling glare. While the invention has been described with respect to the illustrated embodiment, it is recognized that numerous modifications and variations in addition to those mentioned herein will occur to those skilled in the art. Accordingly, it is intended that the invention not be limited to the disclosed embodiment, but that it have the full scope permitted by the language of the following claims.

1. A method for detecting and mitigating veiling glare on a photo-sensitive display device that includes an integral distributed array of photo-sensors, the method comprising the steps of:
activating the display device to display information to a viewer;
periodically sampling light intensity data produced by the photo-sensors of the display device;
comparing the sampled light intensity data to a saturation threshold to identify regions of the display device that are washed-out due to veiling glare from sunlight or another light source impinging on the display device;
determining if the identified regions of the display device overlap relevant portions of the displayed information; and
implementing a counter-measure for mitigating the veiling glare when it is determined that the identified regions of the display device overlap relevant portions of the displayed information.

2. The method of claim 1, where the step of implementing a counter-measure includes the step of:
changing an activation of the display device to alter a format of the displayed information.

3. The method of claim 2, including the step of:
changing a font size of the displayed information.

4. The method of claim 2, including the step of:
changing a format of the displayed information so that the overlap between the displayed information and the identified regions of the display device is minimized or eliminated.

5. The method of claim 2, including the step of:
increasing a brightness of the display device, at least in the identified regions of the display device.

6. The method of claim 1, where the step of implementing a counter-measure includes the step of:
activating an alternate device to convey the relevant portions of the displayed information to the viewer.

7. The method of claim 6, where:
the alternate device is an alternate display device.

8. The method of claim 6, where:
the alternate device is an audio device so that the relevant portions of the displayed information are audibly conveyed to the viewer.

9. The method of claim 1, where a cover lens is disposed between the display device and the viewer, and the step of implementing a counter-measure includes the steps of:
estimating an angle of incidence of the sunlight or other light source based on the identified regions of the display device; and
automatically tilting said cover lens away from the estimated angle of incidence to minimize or eliminate the identified regions of the display device.

10. The method of claim 1, where a cover lens is disposed between the display device and the viewer, and the step of implementing a counter-measure includes the step of:
electronically adjusting a polarization characteristic of the cover lens.

11. The method of claim 1, where the display device is a multi-layer display device, and the step of implementing a counter-measure includes the step of:
activating the display device to display the information on a display layer that is shielded from the impinging light.

12. The method of claim 1, including the step of:
ignoring identified regions of the display device that are smaller in size than a calibrated threshold.

13. The method of claim 1, including the step of:
un-doing an implemented counter-measure when the step of comparing the sampled light intensity data to a saturation threshold fails to identify regions of the display device that are washed-out due to veiling glare from sunlight or another light source impinging on the display device.

14. The method of claim 1, including the step of:
retaining an implemented a counter-measure when the step of comparing the sampled light intensity data to a saturation threshold identifies a region of the display device that is washed-out due to veiling glare from sunlight or another light source impinging on the display device, and it is determined that the identified regions of the display device do not overlap relevant portions of the displayed information.
